(19) United States
(12) Patent Application Publication
(10) Pub. No.: US 2012/0223886 A1
(43) Pub. Date: Sep. 6, 2012

(54) Rapid screen control input system

(75) Inventor: Siu-Leong Yu, Taipei City (TW)

(73) Assignee: Sunplus Technology Co., Ltd., Hsinchu (TW)

(21) Appl. No.: 13/067,431

(22) Filed: Jun. 1, 2011

(30) Foreign Application Priority Data
Mar. 4, 2011 (TW) 100107343

(51) Int. Cl. G06F 3/033

(52) U.S. Cl. 345/160; 345/157

(57) ABSTRACT

A rapid screen control input system includes a display device and a remote control. The display device displays a window with a content, and a cursor. The remote control has a plurality of keys, and a set of directional keys which includes a right directional key, a left directional key, an up directional key, and a down directional key for providing a start key and a stop key. The remote control is used for remotely controlling the display device and the cursor. When the cursor is moved to a position within the window, the at least one window can be resized or moved, or the content of the window can be moved, by means of activating the start key and pressing at least one of the directional keys.

### BACKGROUND OF THE INVENTION

1. Field of the Invention

The present invention relates to an input system and, more particularly, to a rapid screen control input system.

2. Description of Related Art

Digital appliances have the essential functions of information sharing, easy use, and personalization. Products including information appliances, Internet appliances, or manufactures for providing personal activities and entertainments can be regarded as a part of digital appliance field. The developing trend to the digital appliance field is focused mostly on LCD TVs, set-top boxes, DVD players, or blue-ray players.

The digital appliances are placed mostly on a living room for entertainments, not for works as provided by a personal computer. Thus, a digital appliance, unlike a personal computer, is not connected to a wired keyboard and mouse, but is operated by a remote control with or without a touch screen, a wireless keyboard, a device with voice and/or gesture recognition, and/or the like for an input. However, the input devices cited above for the digital appliance cannot meet with the user requirements for the cost, the convenience, and the simplicity on learning.

In the U.S. Pat. No. 6,757,707 entitled “Displayed complementary content sources in a web-based TV system” granted to Houghton, et al. has disclosed a Web-based TV system, which uses a remote keyboard and a remote control to input characters and take a control, respectively. In this case, two input devices are applied to operate the TV system, which is inconvenient. Another prior art implements a g-sensor in a remote control so that a user can control a TV via moving the remote control up, down, left, and right. However, in this case, it is unable to input the characters, or accurately control a window zooming and movement.

Therefore, it is desirable to provide an improved rapid screen control input system to mitigate and/or obviate the aforementioned problems.

### SUMMARY OF THE INVENTION

The object of the present invention is to provide a rapid screen control input system, which can increase the control accuracy and use a remote control, a video camera, or a remote control with a g-sensor to rapidly control a window for increasing the user-friendliness on a human-machine interface and the added value on a multimedia display.

According to one aspect of the invention, a rapid screen control input system is provided. The system includes a display device and an input device. The display device displays a window and its content, and a cursor. The input device provides a start function, a move function, and a stop function. The input device remotely controls the display device and the cursor. The input device makes use of the start function, the move function, and the stop function to successively move the cursor from one place to another, so that the cursor is moved from a position to another position successively.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a rapid screen control input system in accordance with a preferred embodiment of the invention;

FIG. 2 is a schematic view of an operation of a rapid screen control input system in accordance with a preferred embodiment of the invention;

FIG. 3 is a schematic view of a remote control in accordance with a preferred embodiment of the invention;

FIGS. 4(A) and 4(B) are schematic views illustrating a movement of a content of window in accordance with a preferred embodiment of the invention;

FIGS. 5(A) and 5(B) are schematic views illustrating another movement of a content of window in accordance with a preferred embodiment of the invention;

FIGS. 6(A) and 6(B) are schematic views illustrating a further movement of a content of window in accordance with a preferred embodiment of the invention;

FIGS. 7(A) and 7(B) are schematic views illustrating an adjustment of a size of window in accordance with a preferred embodiment of the invention;

FIGS. 8(A) and 8(B) are schematic views illustrating another adjustment of a size of window in accordance with a preferred embodiment of the invention;

FIGS. 9(A) and 9(B) are schematic views illustrating a movement of a position of window in accordance with a preferred embodiment of the invention;

FIGS. 10(A) and 10(B) are schematic views illustrating another movement of a position of window in accordance with a preferred embodiment of the invention;

FIG. 11 is a diagram of a nine-square form in accordance with a preferred embodiment of the invention;

FIG. 12 is a graph of a selection of directions in accordance with a preferred embodiment of the invention;

FIGS. 13(A) and 13(B) are schematic views illustrating a further adjustment of a size of window in accordance with a preferred embodiment of the invention;

FIGS. 14(A) and 14(B) are schematic views illustrating a further movement of a position of window in accordance with a preferred embodiment of the invention; and

FIGS. 15(A) and 15(B) are schematic views illustrating a selection of a content of window in accordance with a preferred embodiment of the invention.

### DETAILED DESCRIPTION OF THE PREFERRED EMBODIMENT

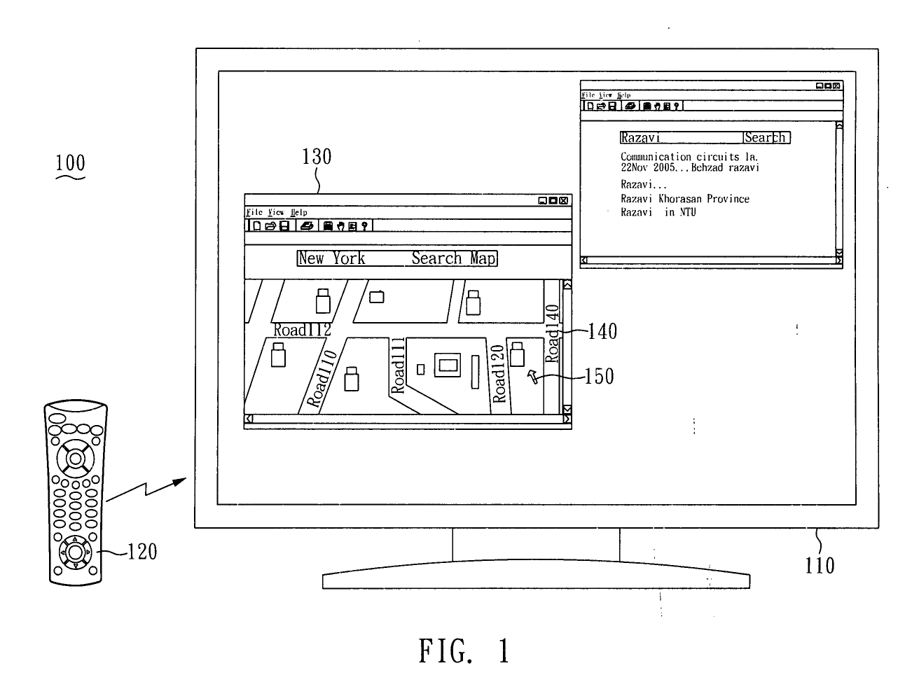

The invention provides a rapid screen control input system, which is used in a Web TV system. FIG. 1 is a schematic view of a rapid screen control input system 100 in accordance with a preferred embodiment of the invention. As shown in FIG. 1, the system includes a display device 110 and an input device 120.

The display device 110 can be operated in a television (TV) mode or a personal computer (PC) mode. When operating in the TV mode, the display device 110 displays the image of an input TV signal. When operating in the PC mode, the display device 110 displays a window 130 and its content 140, and a cursor 150.

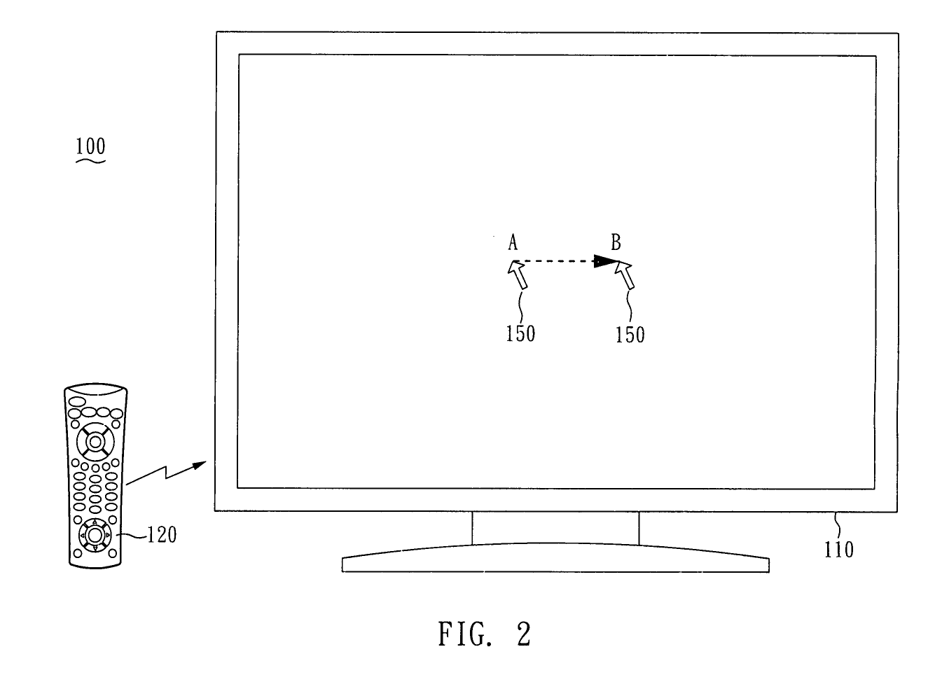

FIG. 2 is a schematic view of an operation of a rapid screen control input system in accordance with a preferred embodiment of the invention. As shown in FIG. 2, the cursor 150 is successively moved from point A to point B by a start-move-and-stop function, so as to remotely control a screen of the display device 110.

Such a function can be used to adjust the size of the window 130, move the position of the window 130, or move the content 140 of the window 130.

The input device 120 provides a start function, a move function, and a stop function. The input device 120 can remotely control the display device 110 and the cursor 150. The input device 120 is preferably a remote control 120. Alternatively, the input device 120 can be a video camera or a remote control with a g-sensor. In this embodiment, the remote control 120 can provide the start-move-and-stop function. In other embodiments, a user gesture captured by the video camera or a sensed gravity signal obtained by the g-sensor of the remote control can be used to achieve the start-move-and-stop function.

Namely, when the input device 120 is a video camera (not shown), the video camera remotely controls the display device 120 and the cursor 150. The user gestures captured by the video camera are used to provide the start-move-and-stop function so as to achieve a successive movement of the cursor 150. Thus, the cursor 150 is moved from one position to another, and the size of the window 130 is adjusted, the position of the window 130 is moved, or the content of the window 130 is moved. The gesture combinations of a user can be predefined for triggering the functions of start, move, and stop operations. For example, the system performs a start operation when the user makes a fist and looses it rapidly; the system performs a corresponding movement operation when the user makes a fist and moves it leftward, rightward, upward, or downward; and the system performs a stop operation when the user makes a fist without any movement. The predefined gestures cited above are for illustrative purpose only. Different gesture combinations can be defined by users or predefined when the system is manufactured in factory.

When the input device 120 is the remote control with the g-sensor (not shown), the input device 120 can remotely control the display device 110 and the cursor 150. The remote control with the g-sensor uses a sensed gravity signal to provide the start-move-and-stop function to complete a successive movement of the cursor 150. Thus, the cursor 150 is moved form one position to another, so as to adjust the size of the window 130, move the position of the window 130, or move the content of the window 130. In this case, it is defined that the system performs a start operation when a user moves the remote control with the g-sensor toward the display device, performs a corresponding move operation when the user moves the remote control upward, downward, leftward, or rightward, and performs a stop operation when the user stays the remote control in a direction vertical to a horizontal plane. The movements of remote control with g-sensor cited above are for illustrative purpose. Different movement combinations can be defined by users or predefined when the system is manufactured in factory.

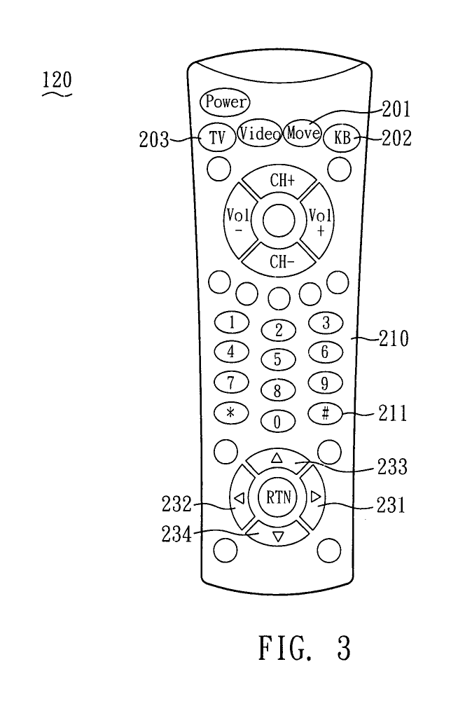

The remote control 120 can remotely control the display device 110. The remote control 120 have a plurality of keys, and a set of directional keys, which includes a right directional key 231, a left directional key 232, an up directional key 233, and a down directional key 234 for providing a start key and a stop key. The remote control 120 remotely controls the display device 110 and the cursor 150. As shown in FIG. 3, the remote control 120 includes a move key 201, an input key 202, a TV key 203, a set of digit keys 210, a right directional key 231, a left directional key 232, an up directional key 233, and a down directional key 234 for providing a start key and a stop key to perform the start function and the stop function, respectively, and using the set of directional keys to perform the move function. For example, when the TV key 203 of the remote control 120 is pressed once, a switching operation is performed between the TV mode and the PC mode. However, other schemes can be arranged for mode switching. The move key 201 and the input key 202 can be an option, which can be implemented with a physical key or a virtual key. When the move key 201 and the input key 202 do not exist on the remote control 120, the move function corresponding to the move key 201 and the input function corresponding to the input key 202 can be replaced by other keys or combinations of other keys.

When the cursor 150 is moved to a position in the window 130, the start key is enabled, and one of the directional keys, i.e., the right directional key 231, the left directional key 232, the up directional key 233, and the down directional key 234, is pressed, so as to adjust the size of the window 130, move the position of the window 130, or move the content 140 of the window 130.

For moving the content 140 of the window 130, the cursor 150 is moved first to a position in the content of the window 130 as well as the start key is enabled, then the right directional key 231, the left directional key 232, the up directional key 233, and the down directional key 234 are pressed to successively move the content 140 of the window rightward, leftward, upward, and downward respectively, and the stop key is enabled to stop moving the content 140 of the window 130. In this case, the start key and the stop key can be implemented with physical keys on the remote control 120 or with other keys or their combination. For example, the physical keys “*” and “#” can be used as the start key and the stop key respectively, or the keys “#”, “1”, and “0” are pressed sequentially to enable the start key to perform the start function, and the keys “#”, “1”, and “2” are pressed sequentially to enable the stop key to perform the stop function.

When a the same directional key of the set of directional keys is pressed again, it speeds up the movement of the content 140 of the window 130 toward the direction indicated by the directional key, and when a directional key opposite to the first-pressed directional key is pressed, it slows down the movement.

When another directional key different from the first-pressed directional key is pressed, the content 140 of the window 130 is moved toward a direction indicated by a vector combination of directions corresponding to the first-pressed directional key and second-pressed directional key.

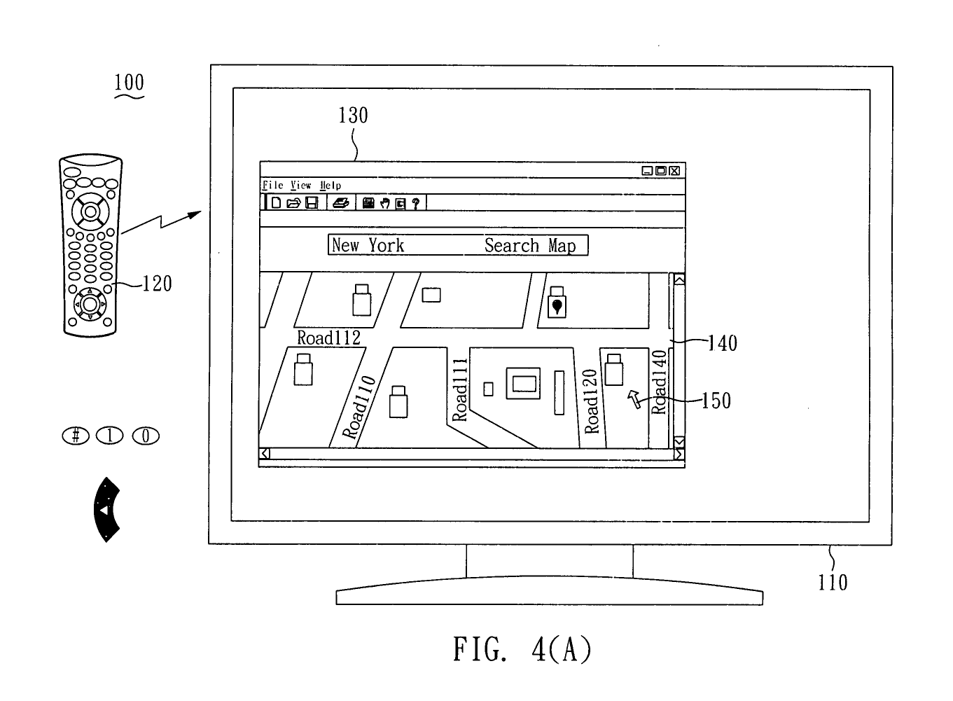

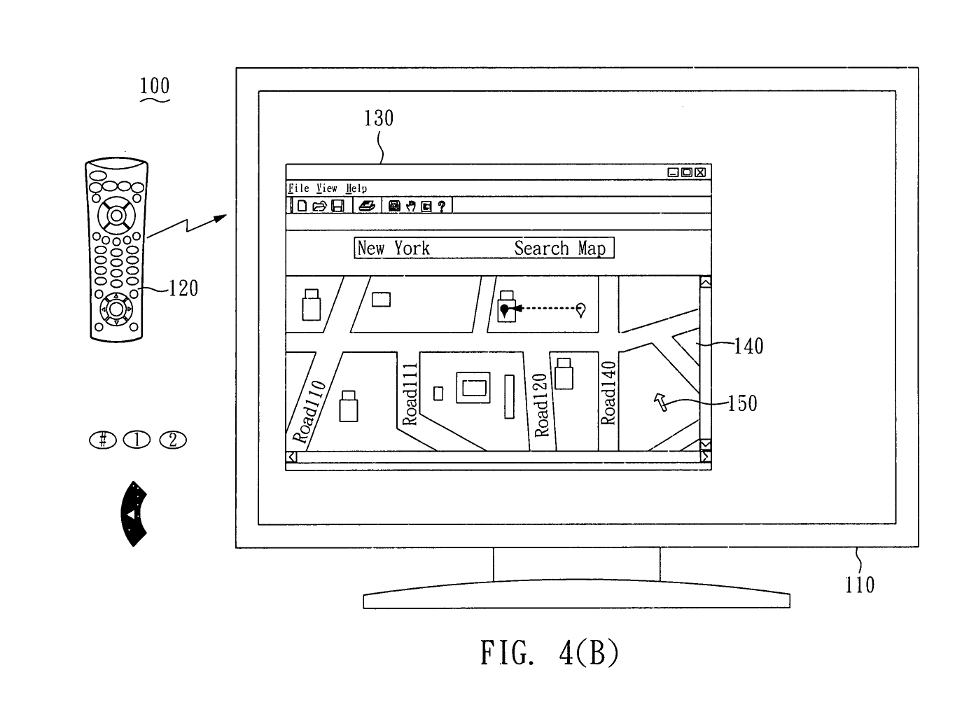

FIGS. 4(A) and 4(B) are schematic views illustrating a movement of a content of window in accordance with a preferred embodiment of the invention. As shown in FIG. 4(A), a user moves the cursor 150 to a position in the content of the window 130, presses the keys “#”, “1”, and “0” sequentially in order to enable the start key, presses the left directional key 232 in order to successively move the content 140 of the window leftward, and presses the keys “#”, “1”, and “2” sequentially in order to enable the stop key so as to stop moving the content 140 of the window 130 left. The result of window movement is shown in FIG. 4(B).

While the content 140 of the window is moved leftward successively, a user can press the left directional key 232 of the set of directional keys again in order to speed up the content 140 of the window 130 to be moved leftward. Conversely, when the right directional key 231 of the set of directional keys is pressed, the movement of the content 140 of the window 130 is slowed down.

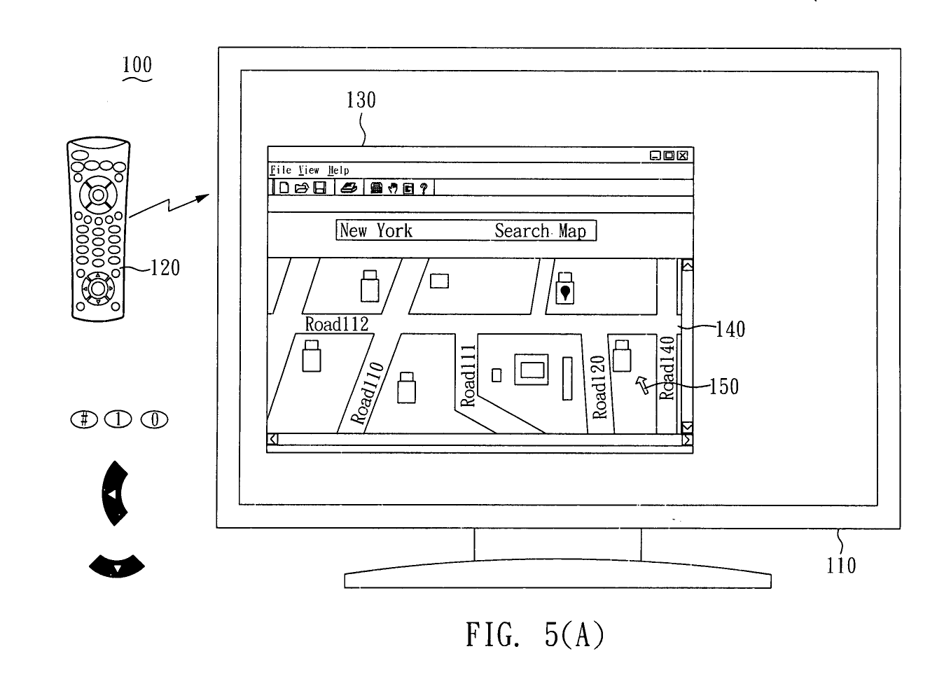

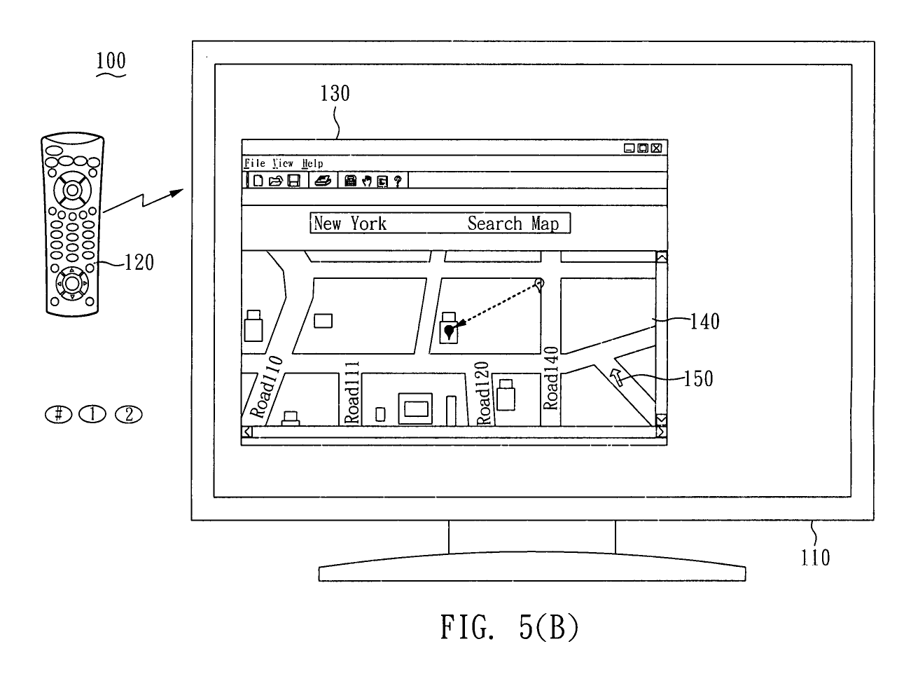

FIGS. 5(A) and 5(B) are schematic views of another movement of a content of window in accordance with a preferred embodiment of the invention. As shown in FIG. 5(A), as cited, while the content 140 of the window is moved leftward successively as the left directional key 232 is pressed, the down directional key 234 of the directional keys is pressed, and the content 140 of the window 130 is moved toward a direction indicated by a vector combination of leftward and downward directions. Namely, the window 130 in this case is moved toward the lower left direction, as shown in FIG. 5(B).

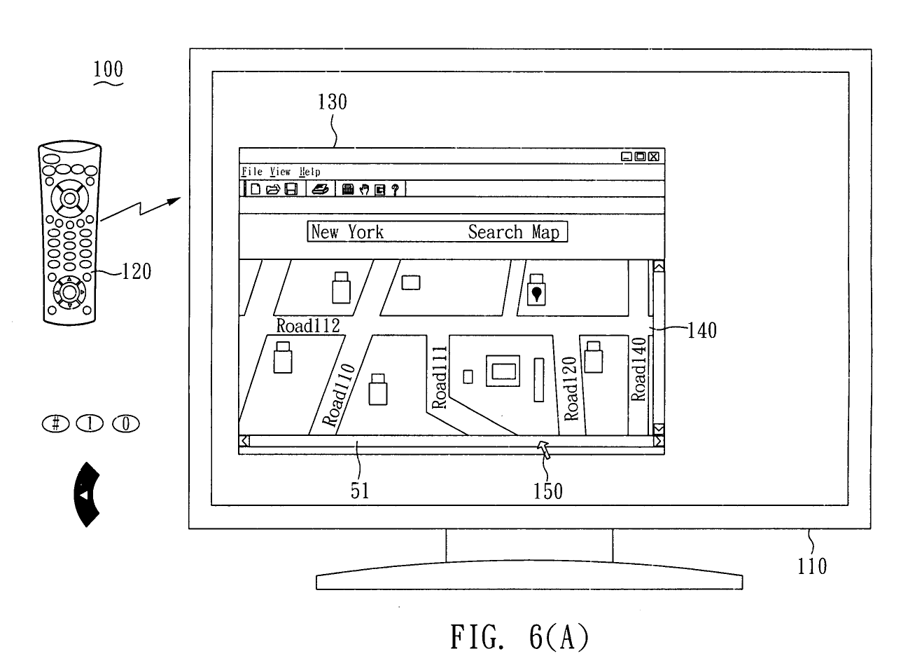

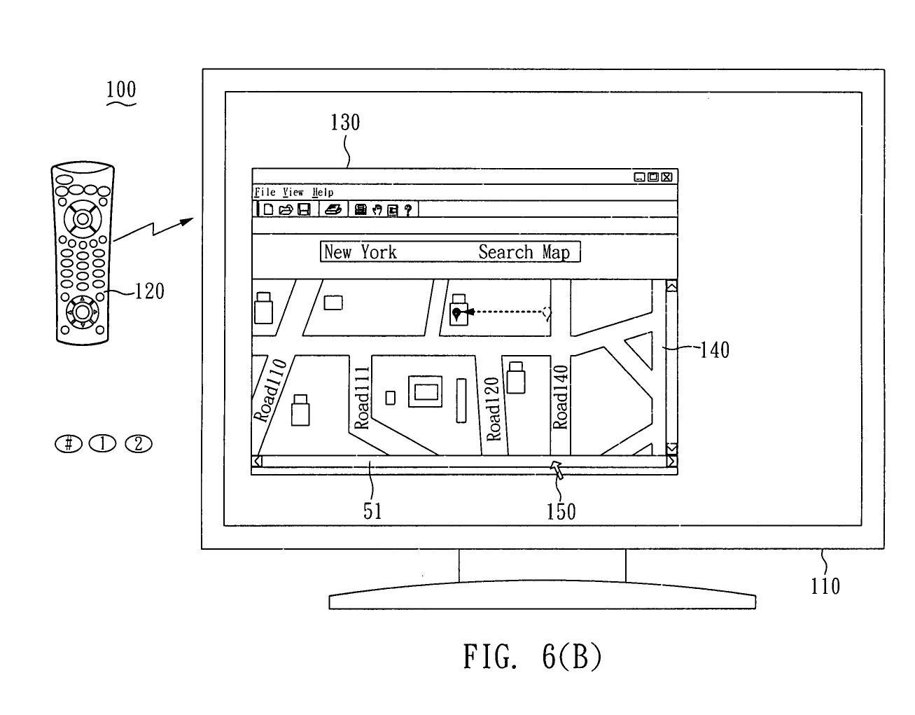

FIGS. 6(A) and 6(B) are schematic views of a further movement of a content of window in accordance with a preferred embodiment of the invention. In this case, the cursor 150 is moved to the scrollbar 51 of the window 130 as well as the start key is enabled, then the right directional key 231, the left directional key 232, the up directional key 233, and the down directional key 234 are pressed to successively move the content 140 of the window 130 rightward, leftward, upward, and downward respectively, and the stop key is enabled to stop moving the content 140 of the window 130. Specially, as shown in FIG. 6(A), a user moves the cursor 150 to the scrollbar 51 of the window 130, the keys “#”, “1”, and “0” are pressed sequentially to enable the start key, the left directional key 232 is pressed to move the content 140 of the window leftward successively, and the keys “#”, “1”, and “2” are pressed sequentially to enable the stop key to stop moving the content 140 of the window 130 leftward. The result of window content movement is shown in FIG. 6(B).

In addition, when the same directional key of the set of directional keys is pressed again, it speeds up the movement of the content 140 of the window 130 toward the direction indicated by the directional key, and when a directional key opposite to the first-pressed directional key is pressed, it slows down the movement of the content 140 of the window 130.

As shown in FIGS. 6(A) and 6(B), the cursor 150 is moved to the horizontal scrollbar 51 of the window 130 in order to perform a horizontal movement on the content of the window 130. However, in other embodiments, the cursor 150 can be moved to a vertical scrollbar or another scrollbar of the window 130 in order to perform a vertical movement or other directional movement.

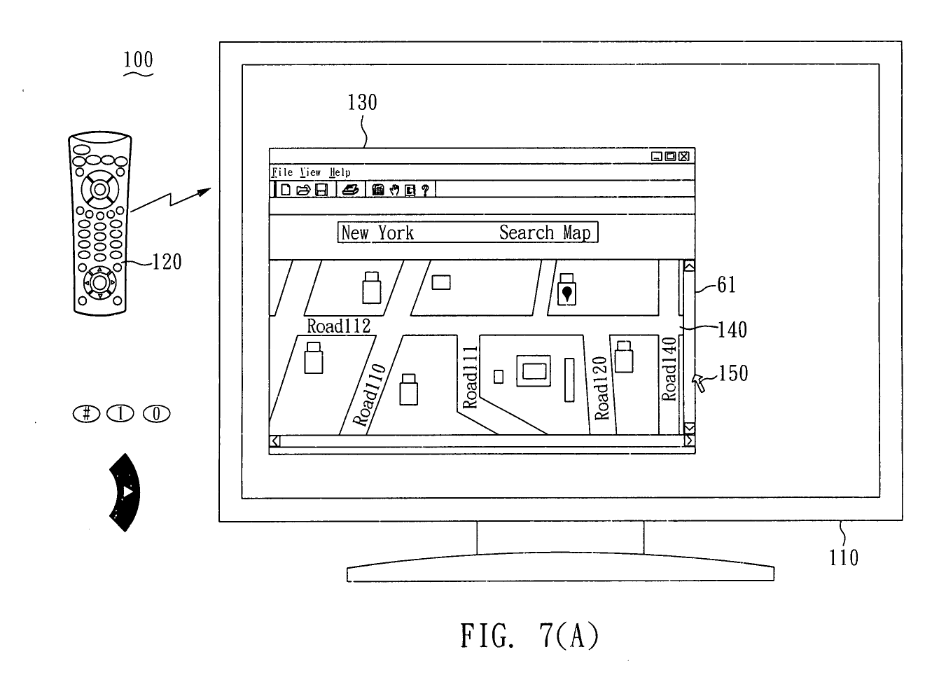

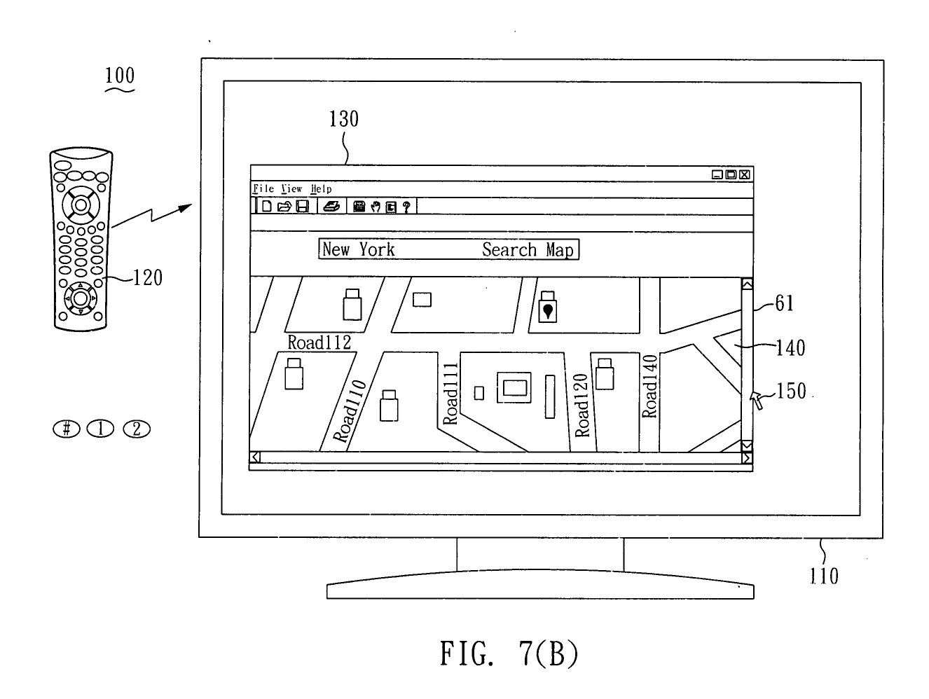

FIGS. 7(A) and 7(B) are schematic views illustrating an adjustment of the size of window in accordance with a preferred embodiment of the invention. In this case, the cursor 150 is moved to an edge 61 of the window 130 as well as the start key is enabled, then the right directional key 231, the left directional key 232, the up directional key 233, and the down directional key 234 are pressed to successively change the size of the window 130 rightward, leftward, upward, and downward respectively, and the stop key is enabled to stop moving the size of the window 130. Specifically, as shown in FIG. 7(A), a user moves the cursor 150 to the edge 61 of the window 130, the keys “#”, “1”, and “0” are pressed sequentially to enable the start key, the right directional key 231 is pressed to change the size of the window rightward successively, and the keys “#”, “1”, and “2” are pressed sequentially to enable the stop key to stop changing the size of the window 130. The result of window size adjustment is shown in FIG. 7(B).

In addition, when the same directional key of the set of directional keys is pressed again, it speeds up the change of the size of the window 130 toward the direction indicated by the directional key, and when a directional key opposite to the first-pressed directional key is pressed, it slows down the change of the size of the window.

When another directional key different from the first-pressed directional key is pressed, the size of the window 130 is changed toward a direction indicated by a vector combination of directions corresponding to the first and second directional keys.

For example, while the size of the window 130 is changed rightward successively, the rightward change of the size of the window 130 is speeded up as a user presses the right directional key 231 of the set of directional keys again, and the change of the size of the window 130 is slowed down as the user presses the left directional key 232.

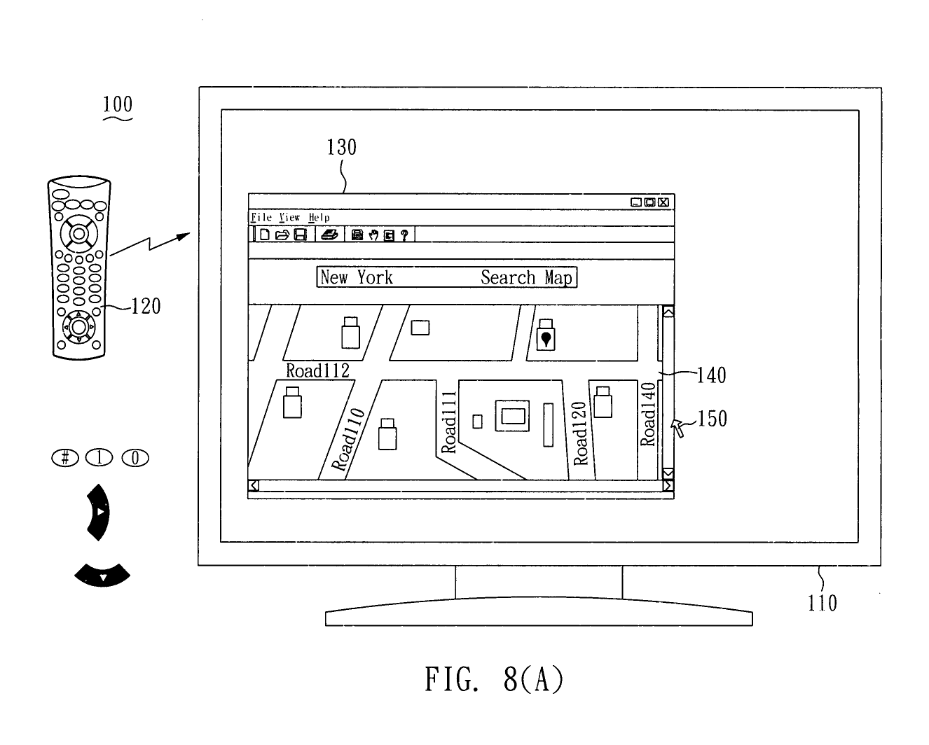

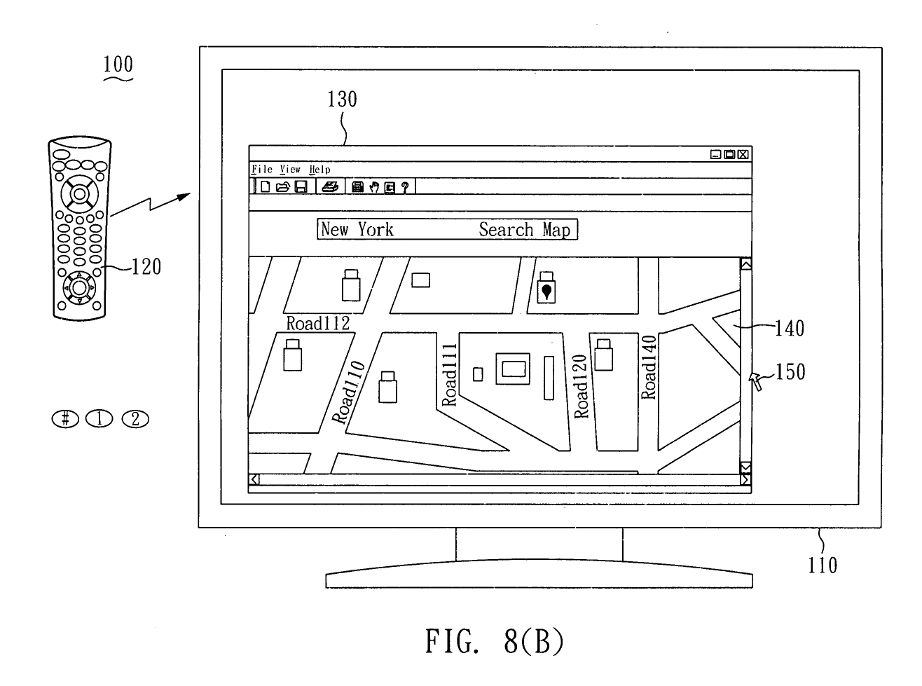

FIGS. 8(A) and 8(B) are schematic views illustrating another adjustment of the size of window in accordance with a preferred embodiment of the invention. As shown in FIG. 8(A), the right directional key 231 is pressed to change the size of the window 130 rightward successively, and subsequently when the down directional key 234 of the directional keys is pressed, the size of the window 130 is changed toward a direction indicated by a vector combination of rightward and downward directions. Namely, the size of window 130 in this case is changed toward the lower right direction, as shown in FIG. 8(B).

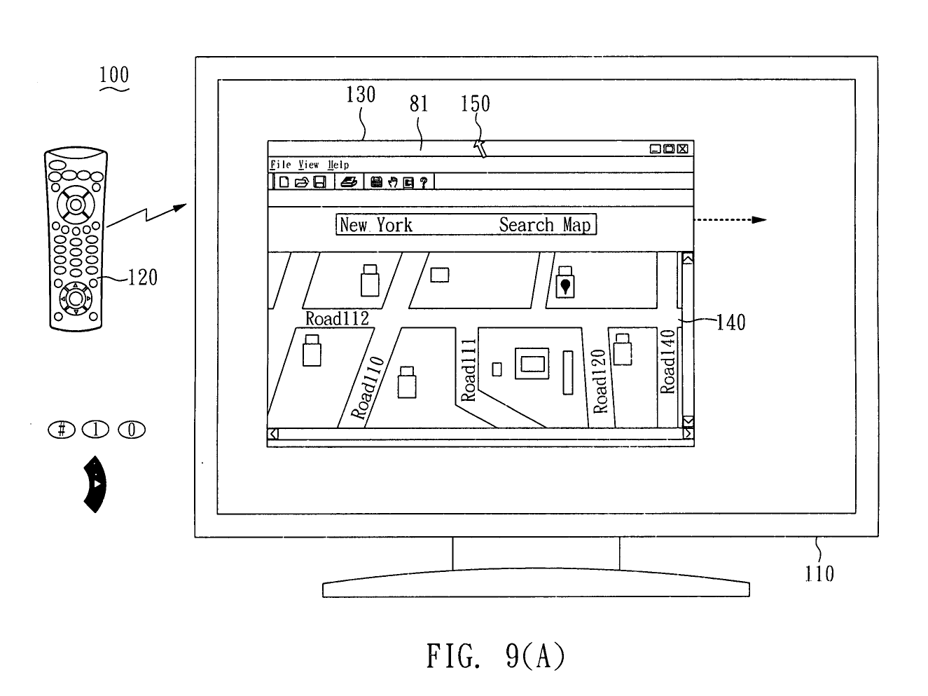

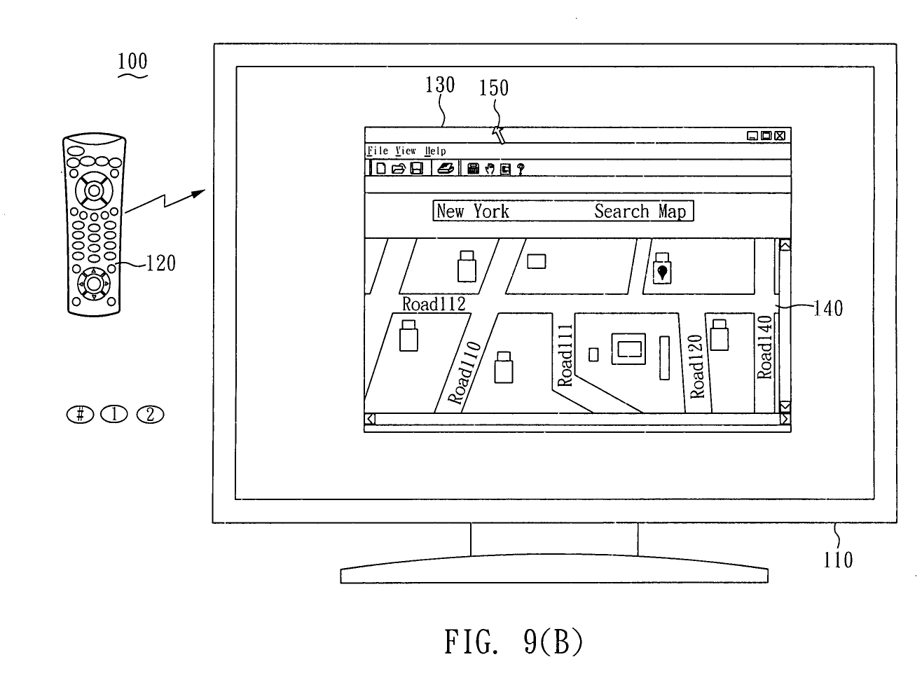

FIGS. 9(A) and 9(B) are schematic views illustrating a movement of the position of window in accordance with a preferred embodiment of the invention. In this case, the cursor 150 is moved to the title bar 81 of the window 130 as well as the start key is enabled, then the right directional key 231, the left directional key 232, the up directional key 233, and the down directional key 234 are pressed to successively move the window 130 rightward, leftward, upward, and downward respectively, and the stop key is enabled to stop moving the position of the window 130. Specifically, as shown in FIG. 9(A), a user moves the cursor 150 to the title bar 81 of the window 130, the keys “#”, “1”, and “0” are pressed sequentially to enable the start key, the right directional key 231 is pressed to move the position of the window rightward successively, and the keys “#”, “1”, and “2” are pressed sequentially to enable the stop key to stop moving the position of the window 130 rightward. The result of window position movement is shown in FIG. 9(B).

In addition, when the same directional key of the set of directional keys is pressed again, it speeds up the movement of the position of the window 130 toward the direction indicated by the directional key, and when a directional key opposite to the first-pressed directional key is pressed, it slows down the movement of the position of the window 130.

When another directional key different from the first-pressed directional key is pressed, the position of the window 130 is moved toward a direction indicated by a vector combination of directions corresponding to the first-pressed directional key and second-pressed directional key.

For example, while the position of the window 130 is moved rightward successively, the rightward movement of the position of the window 130 is speeded up as a user presses the right directional key 231 of the set of directional keys again, and the movement of the position of the window 130 is slowed down as the user presses the left directional key 232.

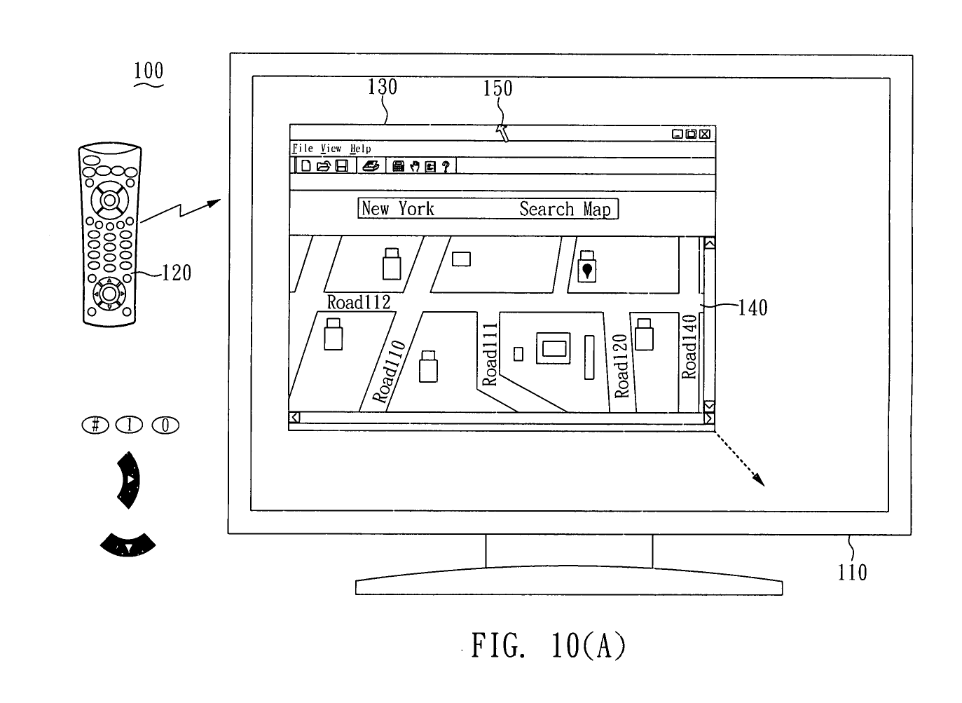

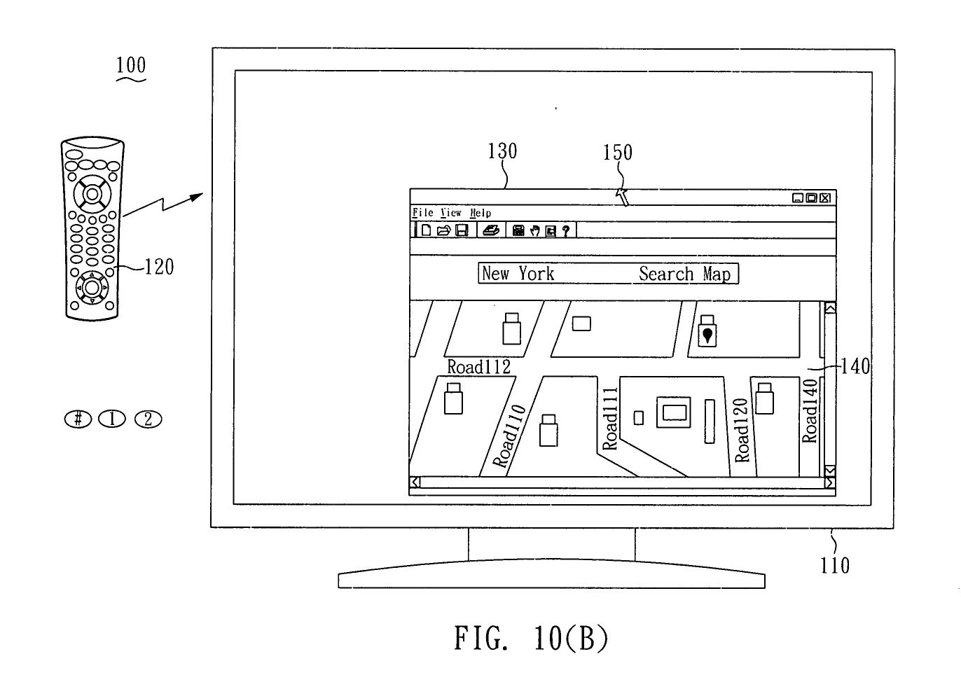

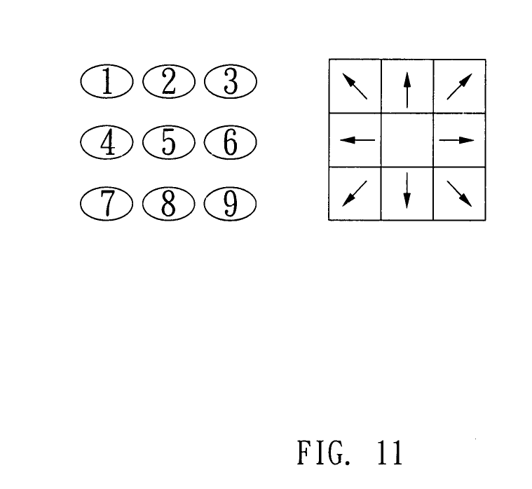

FIGS. 10(A) and 10(B) are schematic views illustrating another movement of the position of window in accordance with a preferred embodiment of the invention. As shown in FIG. 10(A), the position of the window 130 is moved rightward successively when the right directional key 231 is pressed, and moved toward a direction indicated by a vector combination of rightward and downward directions when the down directional key 234 of the directional keys is pressed. Namely, the position of window 130 in this case is moved toward the lower right direction, as shown in FIG. 10(B). The directional keys, including the right directional key 231, the left directional key 232, the up directional key 233, and the down directional key 234, can assign the direction of movement. FIG. 11 is a diagram of a nine-square form in accordance with a preferred embodiment of the invention. As shown in FIG. 11, the digit keys 6, 4, 2, 8 are used as the right directional key 231, the left directional key 232, the up directional key 233, and the down directional key 234 respectively, and the digit keys 1, 3, 7, 9 are used as the upper left direction, the upper right direction, the lower left direction, and the lower right direction respectively. Therefore, eight directions are provided for an option.

In other embodiments, different keys can be used as the right directional key 231, the left directional key 232, the up directional key 233, and the down directional key 234. For example, keys “Vol+”, “Vol−”, “CH+”, and “CH−” on the remote control 120 can be used as the right directional key 231, the left directional key 232, the up directional key 233, and the down directional key 234 respectively.

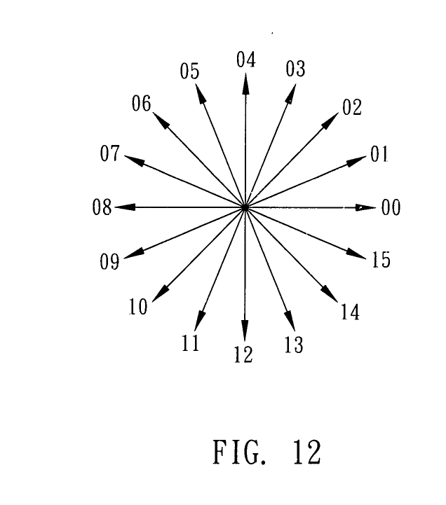

FIG. 12 is a graph of a selection of directions in accordance with a preferred embodiment of the invention. As shown in FIG. 12, 360 degrees are divided equally into 16 parts, with 22.5 degrees each. The direction indicated by the right directional key 231 is selected for an input “00”, and the upper right direction at 22.5 degrees is selected for an input “01”.

In addition, the system can assign a start point “A” and an end point “B” to adjust the size of the window 130, move the position of the window 130, or select the content 140 of the window 130. In this case, the cursor 150 is moved to a position of the window 130, the start key is enabled to assign the start point “A”, and the right directional key 231, the left directional key 232, one of the up directional key 233, and the down directional key 234 of the set of directional keys is pressed to move the cursor 150 to another position of the window 130 in order to enable the stop key to assign the stop point “B”. Accordingly, adjusting the size of the window 130, moving the position of the window 130, or selecting the content 140 of the window 130 are performed with the start point “A” and the stop point “B”.

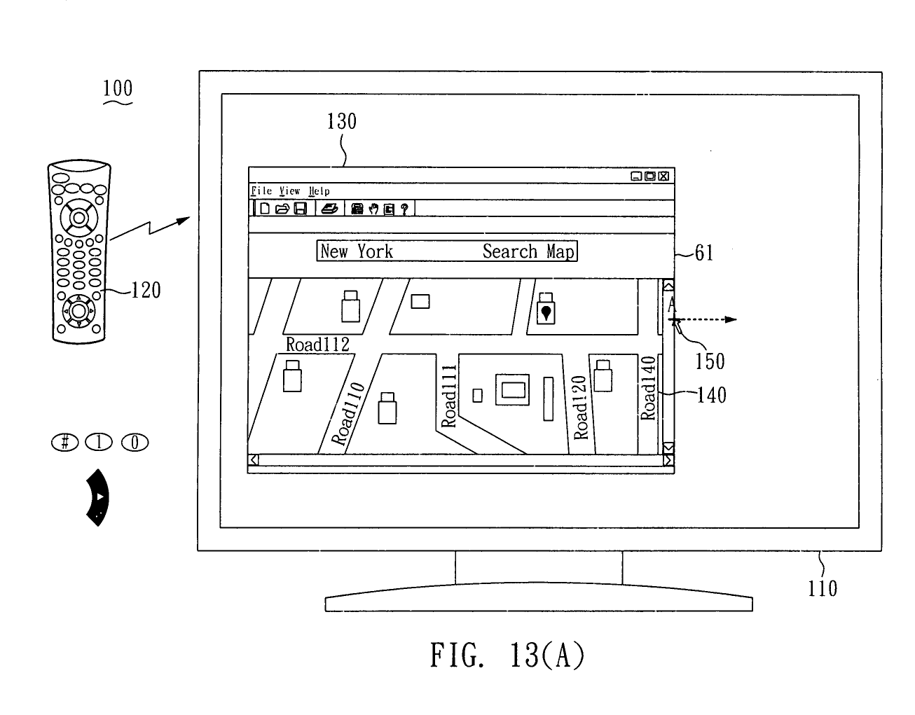

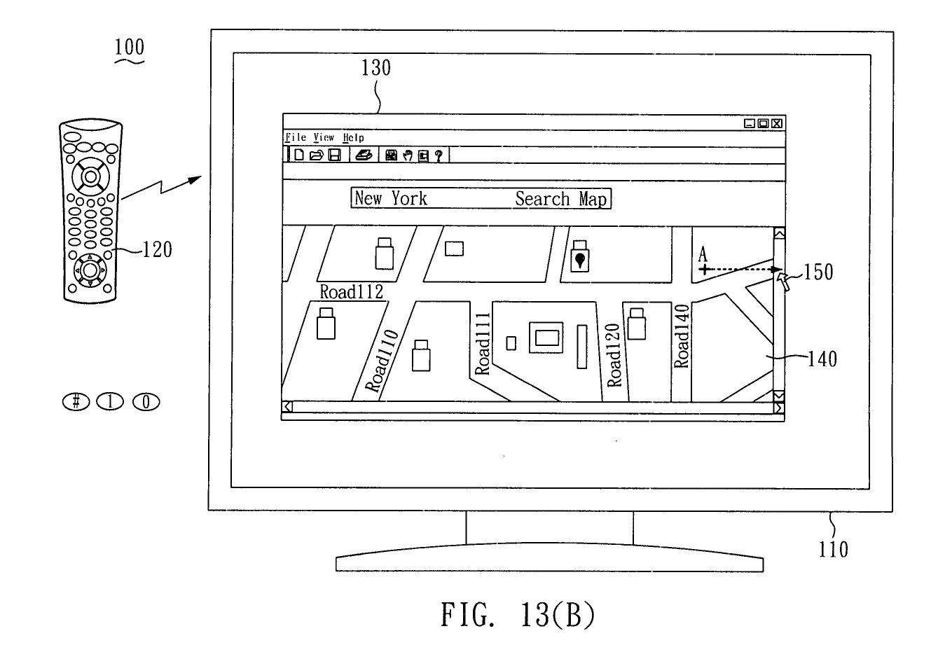

FIGS. 13(A) and 13(B) are schematic views illustrating a further adjustment of the size of window in accordance with a preferred embodiment of the invention. For adjusting the size of the window 130, the cursor 150 is moved to the edge 61 of the window 130, and the start key is enabled to scale the size of the window from the start point “A” to the end point “B”. Specifically, as shown in FIG. 13(A), a user moves the cursor 150 to the edge 61 of the window 130, presses the keys “#”, “1”, and “0” sequentially in order to enable the start key to assign a start point “A”, presses the right directional key 231 so as to move the cursor 150 to another position on the window 130, and presses the keys “#”, “1”, and “2” sequentially in order to enable the stop key to assign a stop point “B”, thereby changing the size of the window 130 rightward successively from the start point “A” to the stop point “B”. The result of window size adjustment is shown in FIG. 13(B).

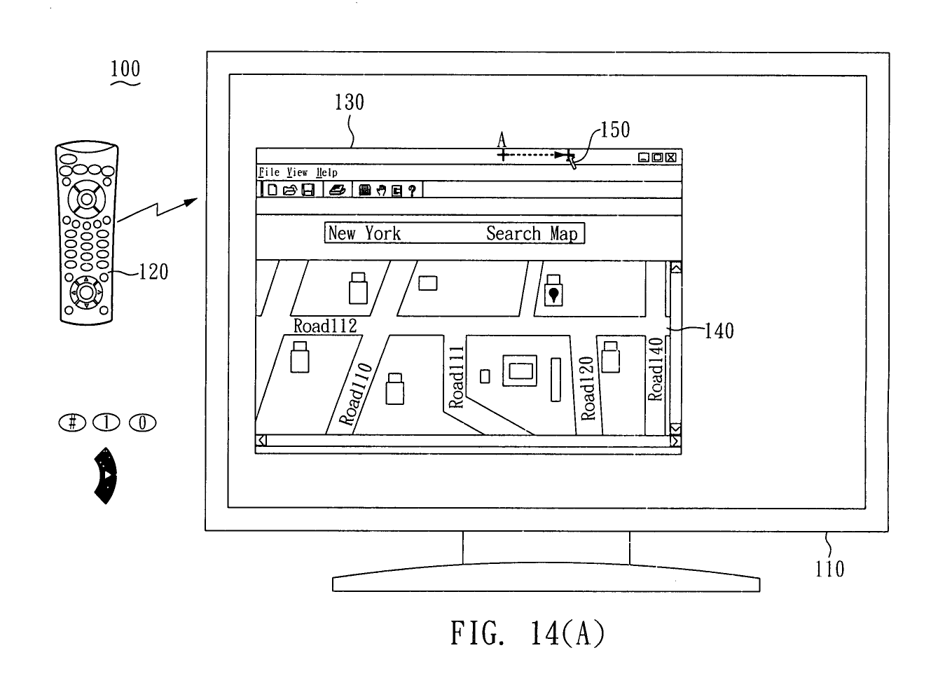

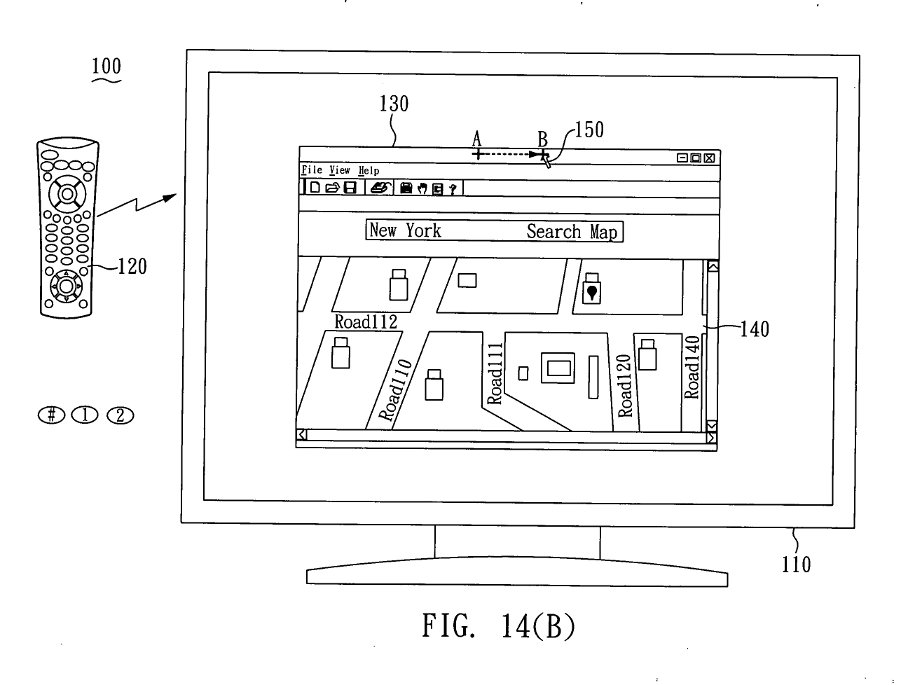

FIGS. 14(A) and 14(B) are schematic views illustrating a further movement of the position of window in accordance with a preferred embodiment of the invention. For moving the position of the window 130, the cursor 150 is moved to the title bar 81 of the window 130 in order to enable the start key so as to move the window from a start point “A” to a stop point “B”. Specifically, as shown in FIG. 14(A), a user moves the cursor 150 to the title bar 81 of the window 130, presses the keys “#”, “1”, and “0” sequentially in order to enable the start key to assign the start point “A”, presses the right directional key 231 so as to move the cursor 150 to another position on the window 130, and presses the keys “#”, “1”, and “2” sequentially in order to enable the stop key to assign the stop point “B”, so as to change the position of the window 130 rightward successively from the start point “A” to the stop point “B”. The result of window position movement is shown in FIG. 14(B).

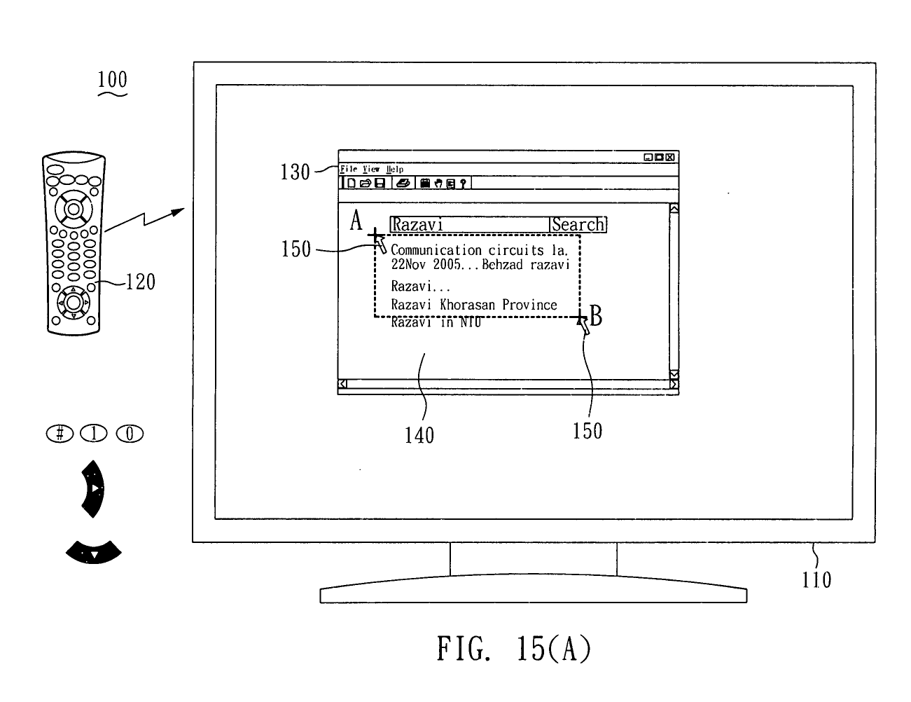

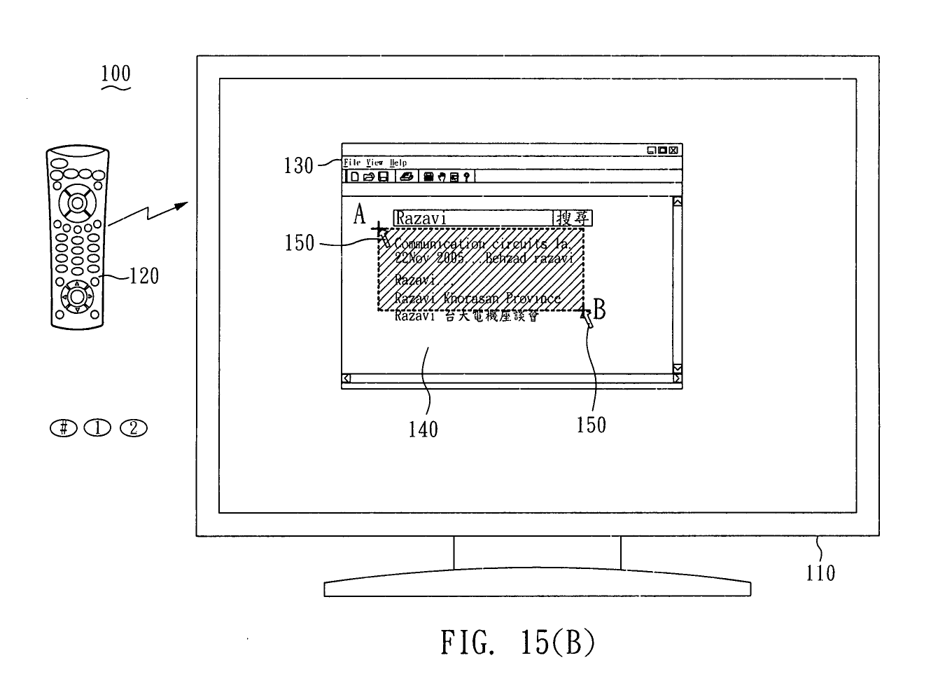

FIGS. 15(A) and 15(B) are schematic views illustrating a selection of the content of window in accordance with a preferred embodiment of the invention. For selecting a content 140 of the window 130, the cursor 150 is moved to a position at the content 140 of the window 130, the start key is enabled to select the content 140 of the window 130 between the start point “A” and the stop point “B”. Specifically, as shown in FIG. 15(A), a user moves the cursor 150 to the position at the content 140 of the window 130, presses the keys “#”, “1”, and “0” sequentially in order to enable the start key to assign the start point “A”, presses the right directional key 231 and/or the down directional key 233 so as to move the cursor 150 to another position on the window 130, and presses the keys “#”, “1”, and “2” sequentially in order to enable the stop key to assign the stop point “B”, thereby selecting the content of the window 130 between the start point “A” and the stop point “B”. The result of window content selection is shown in FIG. 15(B).

In other embodiments, the keys “#”, “1”, and “0” can be pressed sequentially to enable the start key for moving the content 140 of the window 130, the keys “#”, “1”, and “1” can be pressed sequentially to enable the start key for adjusting the size of the window 130, the keys “#”, “1”, and “2” can be pressed sequentially to enable the start key for moving the position of the window 130, the keys “#”, “1”, and “3” can be pressed sequentially to enable the start key for selecting the content of the window 130, and the keys “#”, “1”, and “4” can be pressed sequentially to enable the stop key. Alternatively, the start key and the stop key can be indicated by the keys “*” and “#” or the move key 201 and the input key 202 respectively.

In addition, a register (not shown) can be implemented on the display device 110 in order to temporarily store moved pixels in the window 130 during an operation. The register internally contains a predetermined value of 1. Namely, when the content 140 of the window 130 is moved successively, one pixel is moved at a time. A user can define the content of the register through the remote control 120. For example, if the register is set to five, it indicates that five pixels are moved at a time when the content 140 of the window 130 is moved successively.

In the invention, the rapid screen control input system uses a start-move-and-stop function to complete the successive movement of the cursor 150. The start-move-and-stop function can be implemented as a physical key on the remote control 120, or implemented as a virtual key indicated by one or more keys on the remote control 120. For example, the key “*” is used as the start key while the key “#” is used as the stop key, the keys “#”, “1”, and “0” are pressed sequentially to indicate the start key while the keys “#”, “1”, and “2” are pressed sequentially to indicate the stop key, or the keys “#”, “1”, and “0” are pressed to indicate the start key while the keys “#”, “1”, and “0” are pressed again to indicate the stop key.

The start-move-and-stop function can be used to adjust the size of the window 130, move the position of the window 130, or move the content 140 of the window 130. For example, pressing the keys “#”, “3”, and “1” is defined as an operation of moving the content 140 of the window 130, pressing the keys “#”, “3”, and “2” is defined as an operation of adjusting the size of the window 130, pressing the keys “#”, “3”, and “3” is defined as an operation of moving the position of the window 130, and pressing the keys “#”, “3”, and “4” is defined as an operation of selecting the content of window.

As cited, compared with the prior art, the rapid screen control input system having a typical remote control, a remote control with a g-sensor, or a video camera with a g-sensor in the invention can have a higher control accuracy to rapidly control the window, and further make the human-machine interface more user-friendly.

Although the present invention has been explained in relation to its preferred embodiment, it is to be understood that many other possible modifications and variations can be made without departing from the spirit and scope of the invention as hereinafter claimed.

What is claimed is:

1. A rapid screen control input system, comprising:
a display device for displaying a window, a content of the window, and a cursor; and
an input device for providing a start function, a move function, and a stop function so as to remotely control the display device and the cursor;
wherein the input device makes use of the start function, the move function, and the stop function to complete a successive movement of the cursor, so that the cursor is moved from a position to another position successively.

2. The system as claimed in claim 1, wherein the input device is a remote control which has a plurality of keys and a set of directional keys comprised of a right directional key, a left directional key, an up directional key, and a down directional key for providing a start key and a stop key to perform the start function and the stop function respectively, and using the set of directional keys to perform the move function; and wherein, after the cursor is moved to a position within the window, a size of the window is adjusted or a position of the window is moved or the content of the window is moved by enabling the start key and pressing at least one of the right directional key, the left directional key, the up directional key and the down directional key.

3. The system as claimed in claim 2, wherein, for moving the content of the window, the cursor is moved to a position in the content of the window as well as the start key is enabled, then the right directional key, the left directional key, the up directional key, and the down directional key are pressed to successively move the content of the window rightward, leftward, upward, and downward respectively, and finally the stop key is enabled to stop moving the content of the window.

4. The system as claimed in claim 3, wherein moving the content of the window is speeded up toward a direction indicated by a first directional key which is originally pressed and now pressed again, and slowed down when a directional key opposite to the first directional key is pressed.

5. The system as claimed in claim 4, wherein, when a second directional key different from the first directional key is pressed, the content of the window is moved toward a direction indicated by a vector combination of directions corresponding to the first directional key and the second directional key.

6. The system as claimed in claim 2, wherein the cursor is moved to a scrollbar of the window as well as the start key is enabled, then the right directional key, the left directional key, the up directional key, and the down directional key are pressed to successively move the content of the window rightward, leftward, upward, and downward respectively, and finally the stop key is enabled to stop moving the content of the window.

7. The system as claimed in claim 6, wherein moving the content of the window is speeded up toward a direction indicated by a first directional key which is originally pressed and now pressed again, and slowed down when a directional key opposite to the first directional key is pressed.

8. The system as claimed in claim 2, wherein the cursor is moved to an edge of the window as well as the start key is enabled, then the right directional key, the left directional key, the up directional key, and the down directional key are pressed to successively change the size of the window rightward, leftward, upward, and downward respectively, and finally the stop key is enabled to stop changing the size of the window.

9. The system as claimed in claim 8, wherein changing the size of the window is speeded up toward a direction indicated by a first directional key which is originally pressed and now pressed again, and slowed down when a directional key opposite to the first directional key is pressed.

10. The system as claimed in claim 8, wherein, when a second directional key different from the first directional key is pressed, the size of the window is changed toward a direction indicated by a vector combination of directions corresponding to the first directional key and the second directional key.

11. The system as claimed in claim 2, wherein, for moving the position of the window, the cursor is moved to a title bar of the window as well as the start key is enabled, then the right directional key, the left directional key, the up directional key, and the down directional key are pressed to successively move the position of the window rightward, leftward, upward, and downward respectively, and finally the stop key is enabled to stop moving the position of the window.

12. The system as claimed in claim 11, wherein moving the position of the window is speeded up toward a direction indicated by a first directional key which is originally pressed and now pressed again, and slowed down when a directional key opposite to the first directional key is pressed.

13. The system as claimed in claim 12, wherein, when a second directional key different from the first directional key is pressed, the position of the window is moved toward a direction indicated by a vector combination of directions corresponding to the first directional key and the second directional key.

14. The system as claimed in claim 2, wherein the start key is enabled to assign a start point, then at least one of the right directional key, the left directional key, the up directional key, and the down directional key is pressed to move the cursor to another position of the window, and finally the stop key is enabled to assign a stop point, so as to use the start point and the stop point to adjust the size of the window, move the position of the window, or select the content of the window.

15. The system as claimed in claim 14, wherein, for adjusting the size of the window, the cursor is moved to an edge of the window, and the start key is enabled to scale the size of the window from the start point to the stop point.

16. The system as claimed in claim 14, wherein, for moving the position of the window, the cursor is moved to a title bar of the window, and the start key is enabled to move the window from the start point to the stop point.

17. The system as claimed in claim 14, wherein, for selecting the content of the window, the cursor is moved to a position in the content of the window, and the start key is enabled to select the content of the window between the start point and the stop point.

18. The system as claimed in claim 1, wherein the input device is a video camera for capturing user gestures in order to remotely control the display device and the cursor; and wherein the video camera makes use of the captured user gestures to provide a start function, a move function, and a stop function to complete a successive movement of the cursor from a position to another position so as to adjust a size of the window, move a position of the window, or move a content of the window.

19. The system as claimed in claim 1, wherein the input device is a remote control with a g-sensor for remotely controlling the display device and the cursor; and wherein the remote control with the g-sensor uses a sensed gravity signal to provide a start function, a move function, and a stop function to complete a successive movement of the cursor from a position to another so as to adjust a size of the window, move a position of the window, or move a content of the window.
